(19) United States
(12) Patent Application Publication
(10) Pub. No.: US 2011/0041259 A1
(43) Pub. Date: Feb. 24, 2011

(54) STABLE ODORANT SYSTEMS

(76) Inventors: Brian Joseph Loughnane, Fairfield, OH (US); Gregory Scot Miracle, Hamilton, OH (US); Robert Luis Haaga, Dayton, OH (US); Jonathan Richard Clare, Jesmond (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/916,992

(22) Filed: Nov. 1, 2010

Related U.S. Application Data
(63) Continuation of application No. 12/684,230, filed on Jan. 8, 2010.
Application No. 12/684,230 is a continuation of application No. 11/603,797, filed on Nov. 22, 2006, now abandoned.
(60) Provisional application No. 60/812,778, filed on Jun. 12, 2006.
(60) Provisional application No. 60/764,264, filed on Feb. 1, 2006.
(60) Provisional application No. 60/740,187, filed on Nov. 28, 2005.

(51) Int. Cl. D06L 1/16; C11D 3/60

(52) U.S. Cl. 8/137; 510/302

(57) ABSTRACT

This invention relates to stable odorant systems, compositions comprising such systems, and processes for making and using such systems and compositions.

### CROSS-REFERENCES TO RELATED APPLICATIONS

This application is a continuation of and claims priority under 35 U.S.C. §120 to U.S. patent application Ser. No. 12/684,230 filed Aug. 4, 2010, which in turn is a continuation of and claims priority under 35 U.S.C. §120 to U.S. patent application Ser. No. 11/603,797 filed Nov. 22, 2006, which in turn claims priority under 35 U.S.C. §119(e) to U.S. Provisional Application Ser. No. 60/812,778 filed Jun. 12, 2006, U.S. Provisional Application Ser. No. 60/764,264 filed Feb. 1, 2006, and U.S. Provisional Application Ser. No. 60/740,187 filed Nov. 28, 2005.

### FIELD OF INVENTION

This invention relates to stable odorant systems, compositions comprising such systems and processes for making and using such systems and compositions.

### BACKGROUND OF THE INVENTION

Oxygen bleaching agents, for example hydrogen peroxide, are typically used to facilitate the removal of stains and soils from clothing and various surfaces. Unfortunately such agents are extremely temperature rate dependent. As a result, when such agents are employed in colder solutions, the bleaching action of such solutions is markedly decreased.

In an effort to resolve the aforementioned performance problem, the industry developed a class of materials known as “bleach activators”. However, as such materials rapidly lose their effectiveness at solution temperatures of less than 40° C., new organic catalysts such as 3,4-dihydro-2[2-(sulfooxy)decyl]isoquinolimium, inner salt were developed. In general, while such current art catalysts are effective in lower temperature water conditions, they can have a deleterious impact on odorants. As cleaning and/or treatment compositions comprising stable perfumes and an organic catalyst are desirable, there is a need to provide such systems and methods of producing and selecting same.

### SUMMARY OF THE INVENTION

This invention relates to stable odorant systems, compositions comprising such systems and processes for making and using such systems and compositions.

### DETAILED DESCRIPTION OF THE INVENTION

### Definitions

As used herein, the term “cleaning composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, laundry bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein, the phrase “is independently selected from the group consisting of . . . ” means that moieties or elements that are selected from the referenced Markush group can be the same, can be different or any mixture of elements.

As used herein, the terms “perfume” and “odorant” are synonymous.

As used herein, the articles “a” and “an” when used in the specification or a claim, are understood to mean one or more of what is claimed or described.

The test methods disclosed in the Test Methods Section of the present application must be used to determine the respective values of the parameters of Applicants' inventions.

For purposes of the present specification, “hydrophilic organic catalysts” mean organic catalysts having a log P_{o/w} less than about 0, or even less than about −0.5.

For purposes of the present specification, “hydrophobic organic catalysts” mean organic catalysts having a log P_{o/w} greater than or equal to 0.5, or even greater than or equal to 1.

For the purposes of the present specification, an oxygen transfer agent is designated as hydrophilic or hydrophobic based upon the designation of the parent organic catalyst from which it is derived, the latter determined based on log P_{o/w} criteria disclosed above in the definitions of “hydrophilic and hydrophobic organic catalysts”.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

### Cleaning Compositions Comprising Stable Odorant Systems

One aspect of the invention relates to a composition comprising an odorant system selected from the group consisting of System A, System B and mixtures thereof, wherein: System A comprises an organic catalyst and a source of active oxygen, an oxygen transfer agent or mixture thereof; an electron poor odorant; and at least one adjunct ingredient; System B comprises a surface active agent; a hydrophilic organic catalyst and a source of active oxygen, a hydrophilic oxygen transfer agent or mixtures thereof; a hydrophobic, electron rich odorant; provided that when said composition comprises a mixture of System A and System B, the organic catalyst, oxygen transfer agent or mixture thereof of System A is hydrophilic.

In one aspect of the invention, the composition comprises System A.

In another aspect of the invention, the composition comprises System B.

When said composition comprises System A, said composition may have a ratio of electron poor odorant to organic catalyst, an oxygen transfer agent or mixture thereof of from about 2000:1 to about 1:1, from about 800:1 to about 2:1, or even from about 250:1 to about 5:1. When said composition comprises System A, the electron poor odorant may have an Electrophilic Frontier Density, abbreviated as EFD, of from about 0 to less than about 0.41 or even less than about 0.38, or even less than about 0.35, no double bond having a DBC greater than or equal to 2, or a combination thereof. Suitable electron poor odorants include, but are not limited to, odorants selected from the group consisting of 1,1′-oxybis-2-propanol; 1,4-cyclohexanedicarboxylic acid, diethyl ester; (ethoxymethoxy)cyclododecane; 1,3-nonanediol, monoacetate; (3-methylbutoxy)acetic acid, 2-propenyl ester; beta-methyl cyclododecaneethanol; 2-methyl-3-[(1,7,7-trimethylbicyclo[2.2.1]hept-2-yl) oxy]-1-propanol; oxacyclohexadecan-2-one; alpha-methyl-benzenemethanol acetate; trans-3-ethoxy-1,1,5-trimethylcyclohexane; 4-(1,1-dimethylethyl)cyclohexanol acetate; dodecahydro-3a,6,6,9a-tetramethylnaphtho[2,1-b]furan; beta-methyl benzenepropanal; beta-methyl-3-(1-methylethyl)benzenepropanal; 4-phenyl-2-butanone; 2-methylbutanoic acid, ethyl ester; benzaldehyde; 2-methylbutanoic acid, 1-methylethyl ester; dihydro-5-pentyl-2(3H)furanone; (2E)-1-(2,6,6-trimethyl-2-cyclohexen-1-yl)-2-buten-1-one; dodecanal; undecanal; 2-ethyl-alpha, alpha-dimethylbenzenepropanal; decanal; alpha, alpha-dimethylbenzeneethanol acetate; 2-(phenylmethylene)octanal; 2-[[3-[4-(1,1-dimethylethyl)phenyl]-2-methylpropylidene]amino]benzoic acid, methyl ester; 1-(2,6,6-trimethyl-3-cyclohexen-1-yl)-2-buten-1-one; 2-pentylcyclopentanone; 3-oxo-2-pentyl cyclopentaneacetic acid, methyl ester; 4-hydroxy-3-methoxybenzaldehyde; 3-ethoxy-4-hydroxybenzaldehyde; 2-heptylcyclopentanone; 1-(4-methylphenyl)ethanone; (3E)-4-(2,6,6-trimethyl-1-cyclohexen-1-yl)-3-buten-2-one; (3E)-4-(2,6,6-trimethyl-2-cyclohexen-1-yl)-3-buten-2-one; benzeneethanol; 2H-1-benzopyran-2-one; 4-methoxybenzaldehyde; 10-undecenal; propanoic acid, phenylmethyl ester; beta-methylbenzenepentanol; 1,1-diethoxy-3,7-dimethyl-2,6-octadiene; alpha, alpha-dimethylbenzeneethanol; (2E)-1-(2,6,6-trimethyl-1-cyclohexen-1-yl)-2-buten-1-one; acetic acid, phenylmethyl ester; cyclohexanepropanoic acid, 2-propenyl ester; hexanoic acid, 2-propenyl ester; 1,2-dimethoxy-4-(2-propenyl)benzene; 1,5-dimethyl-bicyclo[3.2.1]octan-8-one oxime; 4-(4-hydroxy-4-methylpentyl)-3-cyclohexene-1-carboxaldehyde; 3-buten-2-ol; 2-[[[2,4(or 3,5)-dimethyl-3-cyclohexen-1-yl]methylene]amino]benzoic acid, methyl ester; 8-cyclohexadecen-1-one; methyl ionone; 2,6-dimethyl-7-octen-2-ol; 2-methoxy-4-(2-propenyl)phenol; (2E)-3,7-dimethyl-2,6-Octadien-1-ol; 2-hydroxy-Benzoic acid, (3Z)-3-hexenyl ester; 2-tridecenenitrile; 4-(2,2-dimethyl-6-methylenecyclohexyl)-3-methyl-3-buten-2-one; tetrahydro-4-methyl-2-(2-methyl-1-propenyl)-2H-pyran; Acetic acid, (2-methylbutoxy)-, 2-propenyl ester; Benzoic acid, 2-hydroxy-, 3-methylbutyl ester; 2-Buten-1-one, 1-(2,6,6-trimethyl-1-cyclohexen-1-yl)-, (Z)-; Cyclopentanecarboxylic acid, 2-hexyl-3-oxo-, methyl ester; Benzenepropanal, 4-ethyl-.alpha.,.alpha.-dimethyl-; 3-Cyclohexene-1-carboxaldehyde, 3-(4-hydroxy-4-methylpentyl)-; Ethanone, 1-(2,3,4,7,8,8a-hexahydro-3,6,8,8-tetramethyl-1H-3a,7-methanoazulen-5-yl)-, [3R-(3.alpha.,3a.beta.,7.beta.,8a.alpha.)]- ; Undecanal, 2-methyl-2H-Pyran-2-one, 6-butyltetrahydro-; Benzenepropanal, 4-(1,1-dimethylethyl)-.alpha.-methyl-; 2(3H)-Furanone, 5-heptyldihydro-; Benzoic acid, 2[(7-hydroxy-3,7-dimethyloctylidene)amino]-, methyl; Benzoic acid, 2-hydroxy-, phenylmethyl ester; Naphthalene, 2-methoxy-; 2-Cyclopenten-1-one, 2-hexyl-; 2(3H)-Furanone, 5-hexyldihydro-; Oxiranecarboxylic acid, 3-methyl-3-phenyl-, ethyl ester; 2-Oxabicyclo[2.2.2]octane, 1,3,3-trimethyl-; Benzenepentanol, .gamma.-methyl-; 3-Octanol, 3,7-dimethyl- and mixtures thereof. Such Markush group of odorants being, for purposes of the present application, designated as Odorant Group 1.

When said composition comprises System B, the ratio of electron rich odorant to hydrophilic organic catalyst, a hydrophilic oxygen transfer agent or mixture thereof may be from about 2000:1 to about 1:1, from about 800:1 to about 2:1, or even from about 250:1 to about 5:1. When said composition comprises System B, said electron rich odorant may have an EFD of greater than or equal to 0.41, greater than or equal to 0.43 but less than about 2, or even greater than or equal to 0.45 but less than about 2, and a log P_{o/w} greater than or equal to 0.5, or even greater than or equal to 1; at least one double bond having a DBC greater than or equal to 2 and a log P_{o/w} greater than or equal to 0.5, or even greater than or equal to 1, or a combination thereof; and said hydrophilic organic catalyst and hydrophilic oxygen transfer agent may have a log P_{o/w}, less than about 0, or even less than about −0.5. Suitable electron rich odorants include, but are not limited to, odorants selected from the group consisting of 3,7-dimethyl-2,6-octadienenitrile; 3,7-dimethyl-6-octen-1-ol; Terpineol acetate; 2-methyl-6-methylene-7-Octen-2-ol, dihydro derivative; 3a,4,5,6,7,7a-hexahydro-4,7-Methano-1H-inden-6-ol propanoate; 3-methyl-2-buten-1-ol acetate; (Z)-3-Hexen-1-ol acetate; 2-ethyl-4-(2,2,3-trimethyl-3-cyclopenten-1-yl)-2-buten-1-ol; 4-(octahydro-4,7-methano-5H-inden-5-ylidene)-butanal; 3-2,4-dimethyl-cyclohexene-1-carboxaldehyde; 1-(1,2,3,4,5,6,7,8-octahydro-2,3,8,8-tetramethyl-2-naphthalenyl)-ethanone; 2-hydroxy-benzoic acid, methyl ester; 2-hydroxy-benzoic acid, hexyl ester; 2-phenoxy-ethanol; 2-hydroxy-benzoic acid, pentyl ester; 2,3-heptanedione; 2-hexen-1-ol; 6-Octen-2-ol, 2,6-dimethyl-; 4,7-Methano-1H-inden-6-ol, 3a,4,5,6,7,7a-hexahydro-, acetate; 9-Undecenal; 8-Undecenal; Isocyclocitral; Ethanone, 1-(1,2,3,5,6,7,8,8a-octahydro-2,3,8,8-tetramethyl-2-naphthalenyl)-; 3-Cyclohexene-1-carboxaldehyde, 3,5-dimethyl-; 3-Cyclohexene-1-carboxaldehyde, 2,4-dimethyl-; 1,6-Octadien-3-ol, 3,7-dimethyl-; 1,6-Octadien-3-ol, 3,7-dimethyl-, acetate; Cyclopentanone, 2-[2-(4-methyl-3-cyclohexen-1-yl)propyl]- and 1-methyl-4-(1-methylethenyl)cyclohexene such Markush group of odorants being, for purposes of the present application, designated as Odorant Group 2.

In any of the aforementioned aspects of the invention, said composition may comprise from about 0.0002% to about 5%, or even from about 0.001% to about 1.5%, weight percent organic catalyst, an oxygen transfer agent or mixture thereof, and when said composition comprises System B, at least 0.1 or even at least 0.2 weight percent surface active agent. Suitable surface active agents include, but are not limited to, a surfactant or surfactant system wherein the surfactant may be selected from nonionic surfactants, anionic surfactants, cationic surfactants, ampholytic surfactants, zwitterionic surfactants, and mixtures thereof.

Any balance of any aspects of the aforementioned cleaning compositions is made up of one or more adjunct materials.

Suitable organic catalysts for System A and for System B include, but are not limited to: iminium cations and polyions; iminium zwitterions; modified amines; modified amine oxides; N-sulfonyl imines; N-phosphonyl imines; N-acyl imines; thiadiazole dioxides; perfluoroimines; cyclic sugar ketones and mixtures thereof—with the proviso that for System B, such catalysts may only be suitable if they are hydrophilic organic catalysts. Suitable iminium cations and polyions include, but are not limited to, N-methyl-3,4-dihydroisoquinolinium tetrafluoroborate, prepared as described in Tetrahedron (1992), 49(2), 423-38 (see, for example, compound 4, p. 433); N-methyl-3,4-dihydroisoquinolinium p-toluene sulfonate, prepared as described in U.S. Pat. No. 5,360,569 (see, for example, Column 11, Example 1); and N-octyl-3,4-dihydroisoquinolinium p-toluene sulfonate, prepared as described in U.S. Pat. 5,360,568 (see, for example, Column 10, Example 3).

Suitable iminium zwitterions include, but are not limited to, N-(3-sulfopropyl)-3,4-dihydroisoquinolinium, inner salt, prepared as described in U.S. Pat. No. 5,576,282 (see, for example, Column 31, Example II); N-[2-(sulfooxy)dodecyl]-3,4-dihydroisoquinolinium, inner salt, prepared as described in U.S. Pat. No. 5,817,614 (see, for example, Column 32, Example V); 2-[3-[2-ethylhexyl)oxy]-2-(sulfooxy)propyl]-3,4-dihydroisoquinolinium, inner salt, and 2-[3-[(2-butyloctyl)oxy]-2-(sulfooxy)propyl]-3,4-dihydroisoquinolinium, inner salt, both prepared as described in the present application in Examples 1 and 2, respectively. Suitable modified amine oxygen transfer catalysts include, but are not limited to, 1,2,3,4-tetrahydro-2-methyl-1-isoquinolinol, which can be made according to the procedures described in Tetrahedron Letters (1987), 28(48), 6061-6064. Suitable modified amine oxide oxygen transfer catalysts include, but are not limited to, sodium 1-hydroxy-N-oxy-N-[2-(sulfooxy)decyl]-1,2,3,4-tetrahydroisoquinoline. Suitable N-sulfonyl imine oxygen transfer catalysts include, but are not limited to, 3-methyl-1,2-benzisothiazole 1,1-dioxide, prepared according to the procedure described in the Journal of Organic Chemistry (1990), 55(4), 1254-61. Suitable N-phosphonyl imine oxygen transfer catalysts include, but are not limited to, [R-(E)]-N-[(2-chloro-5-nitrophenyl)methylene]-P-phenyl-P-(2,4,6-trimethylphenyl)-phosphinic amide, which can be made according to the procedures described in the Journal of the Chemical Society, Chemical Communications (1994), (22), 2569-70. Suitable N-acyl imine oxygen transfer catalysts include, but are not limited to, [N(E)]-N-(phenylmethylene)acetamide, which can be made according to the procedures described in Polish Journal of Chemistry (2003), 77(5), 577-590. Suitable thiadiazole dioxide oxygen transfer catalysts include but are not limited to, 3-methyl-4-phenyl-1,2,5-thiadiazole 1,1-dioxide, which can be made according to the procedures described in U.S. Pat. No. 5,753,599 (Column 9, Example 2). Suitable perfluoroimine oxygen transfer catalysts include, but are not limited to, (Z)-2,2,3,3,4,4,4-heptafluoro-N-(nonafluorobutyl)butanimidoyl fluoride, which can be made according to the procedures described in Tetrahedron Letters (1994), 35(34), 6329-30. Suitable cyclic sugar ketone oxygen transfer catalysts include, but are not limited to, 1,2:4,5-di-O-isopropylidene-D-erythro-2,3-hexodiuro-2,6-pyranose as prepared in U.S. Pat. No. 6,649,085 (Column 12, Example 1).

Sources of active oxygen include, but are not limited to, preformed peracids, a hydrogen peroxide source in combination with a bleach activator, or a mixture thereof. Suitable sources of hydrogen peroxide include, but are not limited to, inorganic perhydrate salts, including alkali metal salts such as sodium salts of perborate (usually mono- or tetra-hydrate), percarbonate, persulphate, perphosphate, persilicate salts and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include inorganic salts such as alkali metal silicate, carbonate or borate salts or mixtures thereof, or organic materials such as water-soluble or dispersible polymers, waxes, oils or fatty soaps.

Suitable activators include, but are not limited to, perhydrolyzable esters, imides, carbonates, carbamates, nitriles, carbodiimides and the like. Examples of suitable activators include, but are not limited to, tetraacetyl ethylene diamine (TAED), benzoylcaprolactam (BzCL), 4-nitrobenzoylcaprolactam, 3-chlorobenzoylcaprolactam, benzoyloxybenzenesulphonate (BOBS), nonanoyloxybenzene-sulphonate (NOBS), phenyl benzoate (PhBz), decanoyloxybenzenesulphonate (C₁₀-OBS), benzoylvalerolactam (BZVL), octanoyloxybenzenesulphonate (C₈-OBS), perhydrolyzable esters, perhydrolyzable imides and mixtures thereof.

Suitable preformed peracids include, but are not limited to, compounds selected from the group consisting of percarboxylic acids and salts, percarbonic acids and salts, perimidic acids and salts, peroxymonosulfuric acids and salts, for example, Oxzone®, and mixtures thereof. Suitable percarboxylic acids include hydrophobic and hydrophilic peracids having the formula R—(C═O)O—O—M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen. Examples of suitable preformed peracids include, but are not limited to, 1,3-dihydro-1,3-dioxo-2H-isoindole-2-hexaneperoxoic acid, nonaneperoxoic acid, dodecaneperoxoic acid, 6-(nonylamino)-6-oxo-hexaneperoxoic acid, and 6-[(1-oxononyl)amino]-hexaneperoxoic acid.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and bleach activator may be selected such that the molar ratio of available oxygen (from the peroxide source) to bleach activator is from 1:1 to 35:1, or even 2:1 to 10:1.

Suitable oxygen transfer agents include, but are not limited to, oxaziridinium cations and polyions; oxaziridinium zwitterions; N-sulfonyl oxaziridines; N-phosphonyl oxaziridines; N-acyl oxaziridines; thiadiazole dioxides; perfluorooxaziridines; cyclic sugar-derived dioxiranes; and mixtures thereof. Such oxygen transfer agents may be prepared by combining an organic catalyst that is described herein with a source of active oxygen that is described herein.

### Odorant Delivery Methods

Any of the aforementioned odorants may be combined with other materials to produce any of the following: starch encapsulated delivery systems, porous carrier material delivery systems, coated porous carrier material delivery systems, microencapsulated delivery systems. Suitable methods of producing the aforementioned delivery systems may be found in one or more of the following U.S. Pat. Nos. 6,458,754; 5,656,584; 6,172,037; 5,955,419 and 5,691,383 and WIPO WIPO publications WO 94/28017, WO 98/41607, WO 98/52527. Such delivery systems may be used, in a consumer product, alone, in combination with each other or even in combination with neat sprayed on or admixed odorants. For example, while electron rich odorants may be employed in compositions comprising a hydrophobic organic catalyst and a source of active oxygen, a hydrophobic oxygen transfer agent or mixture thereof, such odorants may be protected from undesirable oxidation by one or more of the delivery methods described above. In one aspect such protected electron rich odorant may have an EFD of greater than or equal to 0.41, at least one double bond having a DBC greater than or equal to 2, or a combination thereof.

### Adjunct Materials

While not essential for the purposes of the present invention, the non-limiting list of adjuncts illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with colorants, dyes or the like. The precise nature of these additional components, and levels of incorporation thereof, will depend on the physical form of the composition and the nature of the cleaning operation for which it is to be used. Suitable adjunct materials include, but are not limited to, non-essential surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, structure elasticizing agents, fabric softeners, carriers, hydrotropes, processing aids, fillers, solvents and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

As stated, the adjunct ingredients are not essential to Applicants' compositions. Thus, certain embodiments of Applicants' compositions do not contain one or more of the following adjuncts materials: non-essential surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, structure elasticizing agents, fabric softeners, carriers, hydrotropes, processing aids, solvents and/or pigments. However, when one or more adjuncts are present, such one or more adjuncts may be present as detailed below:

Bleaching Agents—The cleaning compositions of the present invention may comprise one or more bleaching agents. Suitable bleaching agents other than organic catalysts, a source of active oxygen, and an oxygen transfer agent include, but not limited to, photobleaches, for example, sulfonated zinc phthalocyanine.

Surfactants—The cleaning compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition.

Builders—The cleaning compositions of the present invention may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1, 3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The cleaning compositions herein may contain a chelating agent. Suitable chelating agents include copper, iron and/or manganese chelating agents and mixtures thereof. When a chelating agent is used, the subject composition may comprise from about 0.005% to about 15% or even from about 3.0% to about 10% chelating agent by weight of the subject composition.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Brighteners—The cleaning compositions of the present invention can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes—The cleaning compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a cleaning composition, the aforementioned enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

Processes of Making Cleaning and/or Treatment Compositions

The cleaning compositions of the present invention can be formulated into any suitable form and prepared by any process chosen by the formulator, non-limiting examples of which are described in Applicants' examples and in U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. 5,486,303 all of which are incorporated herein by reference.

### Method of Use

The present invention includes a method for cleaning a situs inter alia a surface or fabric. Such method includes the steps of contacting an embodiment of Applicants' cleaning composition, in neat form or diluted in a wash liquor, with at least a portion of a surface or fabric then optionally rinsing such surface or fabric. The surface or fabric may be subjected to a washing step prior to the aforementioned rinsing step. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method comprises the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 500 ppm to about 15,000 ppm in solution. The water temperatures typically range from about 5° C. to about 90° C. The water to fabric ratio is typically from about 1:1 to about 30:1.

### Test Methods

1.) Electrophilic Frontier Density: Electrophilic frontier densities are determined, for any given perfume, by optimization using DGauss. DGauss is a molecular density functional program in CAChe Worksystem Pro Version 6.1, supplied by Fujitsu America, Inc. (1250 E. Argues Avenue Sunnyvale, Calif. USA 94085-5401) which uses density functional theory (DFT) for electronic and structural properties of atoms. Such optimization is preformed with the B88-PW91 GGA energy functional with DZVP basis sets. For purposes of the present invention, the perfume's carbon atom having the highest electrophilic frontier density is the EFD of the perfume.
2.) Double Bond Count: The double bond count (DBC) for a carbon-carbon double bond is calculated according to the following formula:

DBCᵢ=x−y+2z
Wherein, for the ith carbon-carbon double bond:
   a.) x is the number of direct attachments from the carbon atoms comprising the double bond to other carbon atoms (excluding those that form the double bond);
   b.) y is the number of direct attachments from the carbon atoms comprising the double bond to a carbon atom that is itself multiply bonded to another atom (e.g., C, O, S, or N, such as a carbonyl carbon, a thiocarbonyl carbon or a nitrile carbon), and
   c.) z is the number of direct attachments from the carbon atoms comprising the double bond to O, S or N.
For the purposes of determining DBC, each aromatic ring is considered to be a double bond and its DBC calculated accordingly.
A compound is considered to be electron poor only if there is no double bond in the compound with a DBC greater than or equal to 2. If a compound has at least one double bond with a DBC greater than or equal to 2, that compound is considered to be electron rich.

### Illustrative Examples:

For the structure:

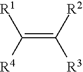

| Entry | R¹ | R² | R³ | R⁴ | x | y | z | DBC |
|---|---|---|---|---|---|---|---|---|
| 1 | H | H | H | Me | 1 | 0 | 0 | 1 |
| 2 | Me | H | H | Me | 2 | 0 | 0 | 2 |
| 3 | Me | H | Me | H | 2 | 0 | 0 | 2 |
| 4 | Me | Me | Me | H | 3 | 0 | 0 | 3 |
| 5 | Me | Me | Me | Me | 4 | 0 | 0 | 4 |
| 6 | H | H | H | OMe | 0 | 0 | 1 | 2 |
| 7 | Me | H | C(O)Me | H | 2 | 1 | 0 | 1 |
| 8 | CO₂H | CO₂H | H | H | 2 | 2 | 0 | 0 |
| 9 | H | CN | Et | H | 2 | 1 | 0 | 1 |
| 10 | H | CO₂Et | H | OMe | 1 | 1 | 1 | 2 |

Example odorant DBCs: 3,7-dimethyl-6-octen-1-ol, DBC=3 (classified as electron rich); 1-methyl-4-(1-methylethenyl)-cyclohexene (2 double bonds in molecule there for; first DBC=3, second DBC=2 thus classified as electron rich); 10-undecenal, DBC=1 (classified as electron poor); 2-hydroxy-benzoic acid, pentyl ester, DBC=2 (classified as electron rich); and 4-phenyl-2-butanone, DBC=1 (classified as electron poor).
3.) Log P_{o/w} is determined according to the method found in Brooke D N, Dobbs A J, Williams N, Ecotoxicology and Environmental Safety (1986) 11(3): 251-260.

### EXAMPLES

Unless otherwise indicated, materials can be obtained from Aldrich, P.O. Box 2060, Milwaukee, Wis. 53201, USA. In Examples 1 and 2, the solvent acetonitrile may be replaced with other solvents, including but not limited to, 1,2-dichloroethane. Perfume materials may be obtained from one or more of the following suppliers: Argeville Kantcheff GmbH, Wiesbaden, Germany; CAPUA s.r.l., 89052 Campo Calabro, Italy; Charabot, Grasse, France; Drom International Inc., Lisle, Ill., USA; Fragrance Resources, Inc Inc., Keyport, N.J., USA; Firmenich S.A., Geneva, Switzerland; Givaudan France S.A., Cedex, France; International Flavors & Fragrances IFF, New Jersey, USA; V. Mane Fils S.A., Le Bar-sur-Loup, France; Millennium, Jacksonville, Fla., USA; Noville, South Hackensack, N.J., USA; PFW Aroma Chemicals B.V., AK Barneveld, The Netherlands; Quest International, Naarden-Bussum, The Netherlands; Soda Aromatic Co., Ltd., Tokyo, Japan; Synarome, Bois Colombes, France; Takasago Int. Corp., Rockleigh, N.J., USA.

### Example 1

### Preparation of Sulfuric Acid mono-[2-(3,4-dihydro-isoquinolin-2-yl)-1-(2-ethylhexyloxymethyl)-ethyl] Ester, Internal Salt

Preparation of 2-ethylhexyl glycidyl ether: To a flame dried, 500 mL round bottomed flask equipped with an addition funnel charged with epichlorohydrin (15.62 g, 0.17 moles), is added 2-ethylhexanol (16.5 g, 0.127 moles) and stannic chloride (0.20 g, 0.001 moles). The reaction is kept under an argon atmosphere and warmed to 90° C. using an oil bath. Epichlorohydrin is dripped into the stirring solution over 60 minutes followed by stiffing at 90° C. for 18 hours. The reaction is fitted with a vacuum distillation head and 1-chloro-3-(2-ethyl-hexyloxy)-propan-2-ol is distilled under 0.2 mm Hg. The 1-chloro-3-(2- ethyl-hexyloxy)-propan-2-ol (4.46 g, 0.020 moles) is dissolved in tetrahydrofuran (50 mL) and stirred at RT under an argon atmosphere. To the stiffing solution is added potassium tert-butoxide (2.52 g, 0.022 moles) and the suspension is stirred at RT for 18 hours. The reaction is then evaporated to dryness, residue dissolved in hexanes and washed with water (100 mL). The hexanes phase is separated, dried with Na₂SO₄, filtered and evaporated to dryness to yield the crude 2-ethylhexyl glycidyl ether, which can be further purified by vacuum distillation.

Preparation of Sulfuric acid mono-[2-(3,4-dihydro-isoquinolin-2-yl)-1-(2-ethylhexyloxymethyl)-ethyl] ester, internal salt: To a flame dried 250 mL three neck round bottomed flask, equipped with a condenser, dry argon inlet, magnetic stir bar, thermometer, and heating bath is added 3,4-dihydroisoquinoline (0.40 mol.; prepared as described in Example 1 of U.S. Pat. No. 5,576,282), 2-ethylhexyl glycidyl ether (0.38 mol, prepared as described above), SO₃-DMF complex (0.38 mol), and acetonitrile (500 mL). The reaction is warmed to 80° C. and stirred at temperature for 72 hours. The reaction is cooled to room temperature, evaporated to dryness and the residue recrystallized from ethyl acetate and/or ethanol to yield the desired product.

### Example 2

### Preparation of Sulfuric Acid mono-[2-(3,4-dihydro-isoquinolin-2-yl)-1-(2-butyl-octyloxymethyl)-ethyl]Ester, Internal Salt

The desired product is prepared according to Example 1, substituting 2-butyloctanol for 2-ethylhexanol.

### Example 3

Bleaching detergent compositions having the form of granular laundry detergents are exemplified by the following formulations.

| | A | B | C | D | E | F |
|---|---|---|---|---|---|---|
| Linear alkylbenzenesulfonate | 20 | 22 | 20 | 15 | 20 | 20 |
| C₁₂ Dimethylhydroxyethyl | 0.7 | 1 | 1 | 0.6 | 0.0 | 0.7 |
| ammonium chloride | | | | | | |
| AE3S | 0.9 | 0.0 | 0.9 | 0.0 | 0.0 | 0.9 |
| AE7 | 0.0 | 0.5 | 0.0 | 1 | 3 | 1 |
| sodium tripolyphosphate | 23 | 30 | 23 | 17 | 12 | 23 |
| Zeolite A | 0.0 | 0.0 | 0.0 | 0.0 | 10 | 0.0 |
| 1.6R Silicate | 7 | 7 | 7 | 7 | 7 | 7 |
| Sodium Carbonate | 15 | 14 | 15 | 18 | 15 | 15 |
| Polyacrylate MW 4500 | 1 | 0.0 | 1 | 1 | 1.5 | 1 |
| Carboxy Methyl Cellulose | 1 | 1 | 1 | 1 | 1 | 1 |
| Savinase 32.89 mg/g | 0.1 | 0.07 | 0.1 | 0.1 | 0.1 | 0.1 |
| Natalase 8.65 mg/g | 0.1 | 0.1 | 0.1 | 0.0 | 0.1 | 0.1 |
| Brightener 15 | 0.06 | 0.0 | 0.06 | 0.18 | 0.06 | 0.06 |
| Brightener 49 | 0.1 | 0.06 | 0.1 | 0.0 | 0.1 | 0.1 |
| Diethylenetriamine | 0.6 | 0.3 | 0.6 | 0.25 | 0.6 | 0.6 |
| pentacetic acid | | | | | | |
| MgSO₄ | 1 | 1 | 1 | 0.5 | 1 | 1 |
| Sodium Percarbonate | 0.0 | 5.2 | 0.1 | 0.0 | 0.0 | 0.0 |
| Photobleach | 0.0030 | 0.0015 | 0.0015 | 0.0020 | 0.0045 | 0.0010 |
| Sodium Perborate | | | | | | |
| Monohydrate | 4.4 | 0.0 | 3.85 | 2.09 | 0.78 | 3.63 |
| NOBS | 1.9 | 0.0 | 1.66 | 1.77 | 0.33 | 0.75 |
| TAED | 0.58 | 1.2 | 0.51 | 0.0 | 0.015 | 0.28 |
| Organic Catalyst | 0.0185 | 0.0185 | 0.0162 | 0.0162 | 0.0111 | 0.0074 |
| Odorant* | 0.05 | 0.1 | 3 | 2 | 1 | 0.5 |
| Sulfate/Moisture | Balance | Balance to | Balance to | Balance | Balance | Balance |
| | to 100% | 100% | 100% | to 100% | to 100% | to 100% |

*Odorant according to the present invention.

Any of the above compositions is used to launder fabrics at a concentration of 3500 ppm in water, 25° C., and a 25:1 water:cloth ratio. The typical pH is about 10 but can be can be adjusted by altering the proportion of acid to Na— salt form of alkylbenzenesulfonate.

### Example 4

Bleaching detergent compositions having the form of granular laundry detergents are exemplified by the following formulations.

| | A | B | C | D |
|---|---|---|---|---|
| Linear alkylbenzene- | 8 | 7.1 | 7 | 6.5 |
| sulfonate | | | | |
| AE3S | 0 | 4.8 | 0 | 5.2 |
| Alkylsulfate | 1 | 0 | 1 | 0 |
| AE7 | 2.2 | 0 | 3.2 | 0.1 |
| C₁₀₋₁₂ Dimethyl | 0.75 | 0.94 | 0.98 | 0.98 |
| hydroxyethyl- | | | | |
| ammonium chloride | | | | |
| Crystalline layered | 4.1 | 0 | 4.8 | 0 |
| silicate (δ-Na₂Si₂O₅) | | | | |
| Zeolite A | 20 | 0 | 17 | 0 |
| Citric Acid | 3 | 5 | 3 | 4 |
| Sodium Carbonate | 15 | 20 | 14 | 20 |
| Silicate 2R | 0.08 | 0 | 0.11 | 0 |
| (SiO₂:Na₂O at ratio 2:1) | | | | |
| Soil release agent | 0.75 | 0.72 | 0.71 | 0.72 |
| Acrylic Acid/Maleic Acid | 1.1 | 3.7 | 1.0 | 3.7 |
| Copolymer | | | | |
| Carboxymethylcellulose | 0.15 | 1.4 | 0.2 | 1.4 |
| Protease (56.00 | 0.37 | 0.4 | 0.4 | 0.4 |
| mg active/g) | | | | |
| Amylase (21.55 | 0.3 | 0.3 | 0.3 | 0.3 |
| mg active/g) | | | | |
| Lipase (11.00 | 0 | 0.7 | 0 | 0.7 |
| mg active/g) | | | | |
| Tetraacetyl ethylene | 3.6 | 4.0 | 3.6 | 4.0 |
| diamine (TAED) | | | | |
| Percarbonate | 13 | 13.2 | 13 | 13.2 |
| Organic Catalyst | 0.04 | 0.02 | 0.01 | 0.06 |
| Na salt of Ethylene- | 0.2 | 0.2 | 0.2 | 0.2 |
| diamine-N,N′-disuccinic | | | | |
| acid, (S,S) isomer (EDDS) | | | | |
| Hydroxyethane di | 0.2 | 0.2 | 0.2 | 0.2 |
| phosphonate (HEDP) | | | | |
| MgSO₄ | 0.42 | 0.42 | 0.42 | 0.42 |
| Odorant* | 0.5 | 0.6 | 0.5 | 0.6 |
| Suds suppressor | 0.05 | 0.1 | 0.05 | 0.1 |
| agglomerate | | | | |
| Soap | 0.45 | 0.45 | 0.45 | 0.45 |
| Sodium sulfate | 22 | 33 | 24 | 30 |
| Sulphonated zinc | 0.07 | 0.12 | 0.07 | 0.12 |
| phtalocyanine | | | | |
| Photobleach | 0.0014 | 0.002 | 0.0014 | 0.001 |
| Speckles | 0.03 | 0.05 | 0.03 | 0.05 |
| Water & Miscellaneous | Balance | Balance | Balance | Balance |
| | to 100% | to 100% | to 100% | to 100% |

*Odorant according to the present invention.

Any of the above compositions is used to launder fabrics at a concentration of 10,000 ppm in water, 20-90° C., and a 5:1 water:cloth ratio. The typical pH is about 10 but can be can be adjusted by altering the proportion of acid to Na— salt form of alkylbenzenesulfonate.

### Example 5

Bleaching detergent compositions having the form of granular laundry detergents are exemplified by the following formulations.

| | A | B | C | D | E | F |
|---|---|---|---|---|---|---|
| Linear Alkylbenzenesulfonate | 19.0 | 15.0 | 20.0 | 19.0 | 18.0 | 17.5 |
| Alkylsulfate | 1.1 | 1.0 | 0.8 | 1.0 | 1.1 | 1.2 |
| AE3S | 0.3 | 0.2 | 0.0 | 0.1 | 0.3 | 0.5 |
| Polyacrylic Acid, partially | 6.0 | 5.5 | 7.5 | 7.0 | 5.8 | 6.0 |
| neutralized | | | | | | |
| Sodium Xylene Sulfonate* | 1.5 | 1.9 | 2.0 | 1.7 | 1.5 | 1.0 |
| PEG 4000 | 0.3 | 0.25 | 0.35 | 0.15 | 0.2 | 0.10 |
| Brightener 49 | 0 | 0 | 0.32 | 0.04 | 0.04 | 0.16 |
| Brightener 15 | 0 | 0 | 0.68 | 0.08 | 0.08 | 0.32 |
| Moisture | 2.50 | 2.00 | 2.90 | 2.20 | 2.40 | 1.80 |
| Sodium carbonate | 20.0 | 17.5 | 21.0 | 20.2 | 19.0 | 18.0 |
| Sodium Sulfate | 0.20 | 0.30 | 0.50 | 0.30 | 0.45 | 0.10 |
| Sodium Silicate | 0.25 | 0.25 | 0.55 | 0.30 | 0.25 | 0.10 |
| Layered Silicate Builder | 2.7 | 3.0 | 2.2 | 3.7 | 1.5 | 1.0 |
| Zeolite A | 11.0 | 11.0 | 12.5 | 10.2 | 9.5 | 8.0 |
| Protease | 0.20 | 0.50 | 1.0 | 0.15 | 0.40 | 0.0 |
| Silicone Suds Suppressor | 0.40 | 0.35 | 1.00 | 0.60 | 0.50 | 0.00 |
| Coarse Sulfate | 21.5 | 23.0 | 21.0 | 21.0 | 20.0 | 18.5 |
| Amine Reaction Product | 0.40 | 0.25 | 0.10 | 0.35 | 0.60 | 0.00 |
| comprising delta-Damascone**** | | | | | | |
| Odorant*** | 0.10 | 0.30 | 0.20 | 0.20 | 0.40 | 0.50 |
| Sodium Percarbonate | 2.8 | 4.5 | 2.00 | 4.7 | 7.4 | 10.0 |
| Conventional Activator (NOBS) | 2.10 | 3.7 | 1.00 | 3.0 | 5.0 | 10.0 |
| Organic Catalyst | 0.005 | 0.10 | 1.00 | 0.25 | 0.05 | 0.05 |
| Bluing agent** | 0.50 | 0.20 | 1.00 | 0.30 | 0.10 | 0.00 |
| Filler | Balance | Balance | Balance | Balance | Balance | Balance |
| | to 100% | to 100% | to 100% | to 100% | to 100% | to 100% |

*Other hydrotropes, such as sodium toluenesulfonate, may also be used.
**Such as Ultramarine Blue or Azo-CM-Cellulose (Megazyme, Bray, Co. Wicklow, Ireland)
***Odorant according to the present invention.
****Prepared according to WO 00/02991, USPN 6,413,920 B1, USPN 6,566,312 B2, and/or USPN 6,790,815 B1.

Any of the above compositions is used to launder fabrics at a concentration of 500-1500 ppm in water, 5-25° C., and a 15:1-25:1 water:cloth ratio. The typical pH is about 9.5-10 but can be can be adjusted by altering the proportion of acid to Na— salt form of alkylbenzenesulfonate.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising
A) an odorant System, wherein said System B comprises:
a) a surface active agent;
b) a hydrophilic organic catalyst having a log P_{o/w} less than about 0, said hydrophilic organic catalyst being selected from the group consisting of iminium cations and polyions; iminium zwitterions; modified amines; modified amine oxides; N-sulfonyl imines; N-phosphonyl imines; N-acyl imines; thiadiazole dioxides; perfluoroimines; cyclic sugar ketones and mixtures thereof, and a source of active oxygen; a hydrophilic oxygen transfer agent; or mixtures thereof;
c) a hydrophobic, electron rich odorant;
B) any balance of said composition comprising one or more additional adjunct ingredients.

2. The composition of claim 1 wherein said composition comprises an electron poor odorant.

3. The composition of claim 1, said composition comprising from about 0.0002% to about 5% weight percent hydrophilic organic catalyst, hydrophilic oxygen transfer agent or mixture thereof and at least 0.1 weight percent surface active agent.

4. The composition of claim 1 wherein the ratio of electron rich odorant to hydrophilic organic catalyst, a hydrophilic oxygen transfer agent or mixture thereof is from about 2000:1 to about 1:1.

5. The composition of claim 1, said composition comprising;
A) an electron rich odorant having an EFD of greater than or equal to 0.43 and a log P_{o/w}, greater than or equal to 1; at least one double bond having a DBC greater than or equal to 2 and a log P_{o/w}, greater than or equal to 1, or a combination thereof; and
B) a hydrophilic organic catalyst and/or hydrophilic oxygen transfer agent having a log P_{o/w}, less than about 0.

6. The composition of claim 1, said composition comprising an electron rich odorant selected from Odorant Group 2.

7. The composition of claim 2 wherein:
A) the ratio of electron poor odorant to organic catalyst, an oxygen transfer agent or mixture thereof is from about 2000:1 to about 1:1; and said electron poor odorant has an EFD of less than 0.41, has no double bond having a DBC greater than or equal to 2 or a combination thereof, and/or said electron poor odorant is selected from Odorant Group 1; and
B) for System B:
a) the ratio of electron rich odorant to organic catalyst, a hydrophilic oxygen transfer agent or mixture thereof is from about 2000:1 to about 1:1; and
b) said electron rich odorant has an EFD of greater than or equal to 0.41 and a log P_{ow} greater than or equal to 0.5; has at least one double bond having a DBC greater than or equal to 2 and a log P_{ow} greater than or equal to 0.5, or a combination thereof; and said hydrophilic organic catalyst and hydrophilic oxygen transfer agent have a log P_{ow}, less than about 0; and/or said electron rich odorant is selected from Odorant Group 2.

8. The composition of claim 7, wherein said composition comprises from about 0.0002% to about 5% weight percent organic catalyst, an oxygen transfer agent or mixture thereof.

9. The composition of claim 8, wherein said composition comprises from about 0.001% to about 1.5% weight percent organic catalyst, an oxygen transfer agent or mixture thereof.

10. The composition of claim 7, wherein the ratio of electron poor odorant to organic catalyst, an oxygen transfer agent or mixture thereof is from about 800:1 to about 2:1 and if present, the ratio of electron rich odorant to organic catalyst, an oxygen transfer agent or mixture thereof is from about 800:1 to about 2:1.

11. The composition of claim 10, wherein the ratio of electron poor odorant to organic catalyst, an oxygen transfer agent or mixture thereof is from about 250:1 to about 5:1 and if present, the ratio of electron rich odorant to organic catalyst, an oxygen transfer agent or mixture thereof is from about 250:1 to about 5:1.

12. A method of cleaning a surface or fabric comprising the steps of contacting said surface or fabric with the cleaning composition of claim 1, then optionally washing and/or rinsing said surface or fabric.

13. A method of cleaning a surface or fabric comprising the steps of contacting said surface or fabric with the cleaning composition of claim 2, then optionally washing and/or rinsing said surface or fabric.

14. A method of cleaning a surface or fabric comprising the steps of contacting said surface or fabric with the cleaning composition of claim 7, then optionally washing and/or rinsing said surface or fabric.

15. A composition comprising a protected electron rich odorant having an EFD of greater than or equal to 0.41, at least one double bond having a DBC greater than or equal to 2, or a combination thereof, and a hydrophobic organic catalyst and a source of active oxygen, a hydrophobic oxygen transfer agent or mixture thereof.
